(19) United States
(12) Patent Application Publication
(10) Pub. No.: US 2009/0132328 A1
(43) Pub. Date: May 21, 2009

(54) METHOD, SYSTEM, AND COMPUTER PROGRAM PRODUCT FOR MANAGING TROUBLE TICKETS OF A NETWORK

(75) Inventors: Sanal Kishore, Silver Spring, MD (US); Nagesha Saligrama, Silver Spring, MD (US); Nilesh Shroff, Silver Spring, MD (US); Kishorraju Budharaju, Silver Spring, MD (US)

Correspondence Address: VERIZON;PATENT MANAGEMENT GROUP, 1320 North Court House Road, 9th Floor, ARLINGTON, VA, 22201-2909, US

(73) Assignee: Verizon Services Corp., Arlington, VA (US)

(21) Appl. No.: 11/942,354

(22) Filed: Nov. 19, 2007

(51) Int. Cl. G06F 11/07; G06Q 10/00

(52) U.S. Cl. 705/9; 714/100; 714/E11.021

(57) ABSTRACT

Methods, systems, and computer program products are provided for managing the trouble tickets of a network. One or more problems within the network along a plurality of lines of the network may be identified and trouble tickets may be opened for the problems. Each trouble ticket may be for dispatching a technician to the field to address the problem that is the subject of the trouble ticket. A certain amount of time may elapse from when the trouble ticket is opened and when the technician is dispatched. During that time the underlining problem may be resolved for various reasons. To detect the resolution of the problem before the dispatching of the technician, the line may be tested at a predetermined interval. If a test indicates that the problem has been resolved the trouble ticket is closed reducing the likelihood that a technician is dispatched for an already resolved problem.

### BACKGROUND INFORMATION

In general, a fiber to the premises (FTTP), also referred to as fiber to the home (FTTH), system includes one or more passive optical networks configured to deliver media content, in the form of optical signals, from a provider's central office to a plurality of subscribers' homes. The passive optical network includes a series of fiber links extending between the central office, homes, and other components of the network. The passive optical networks may extend over large geographic areas and serve hundreds or thousands of subscribers.

A subscriber may call the service provider to report a problem. For example, the subscriber may call to report an interruption of service at his or her home. Often the service provider responds to such a call by scheduling a technician to go out to the home to determine and fix the problem. As the size of the network increases geographically and by the number of subscribers, the service provider may receive hundreds if not thousands of calls from subscribers reporting problems. Because of the number of calls, the service provider may have to employ more technicians and/or increase the amount of time it takes to respond to any one of the calls. More technicians increase the cost of maintaining the network and taking longer to respond to calls decreases customer satisfaction.

### BRIEF DESCRIPTION OF THE SEVERAL VIEWS OF THE DRAWING(S)

FIG. 1 is a block diagram of a fiber network consistent with an exemplary embodiment;

FIG. 2 is another block diagram of the fiber network with more detail regarding the central office of FIG. 1; and

FIG. 3 is a flow chart illustration of a method consistent with an exemplary embodiment.

### DETAILED DESCRIPTION OF PREFERRED EMBODIMENTS

Exemplary embodiments are described hereinafter with reference to the accompanying drawings, in which exemplary embodiments and examples are shown. Like numbers refer to like elements throughout.

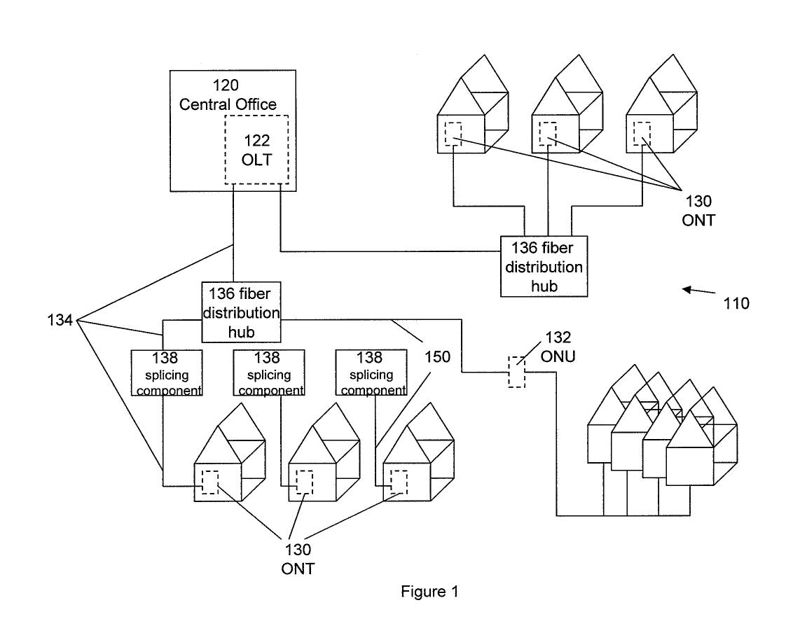

FIG. 1 illustrates a fiber to the premises (FTTP), also referred to as fiber to the home (FTTH), system consistent with some embodiments. The FTTP system may include or otherwise be in communication with a provider's central office 120 that delivers optical signals to a plurality of subscribers through at least one passive optical network (PON) 100. The passive optical network 100 may include an optical line terminal (OLT) 122 at the provider's central office and a plurality of optical network terminals (ONTs) 130 located at the premises of the subscribers, e.g., a customer home, office, or other facility. The passive optical network 10 may also include one or more optical network units (ONUs) 132 that function as gateways to additional sub-networks associated with other systems, such as fiber to the curb (FTTC) and fiber to the neighborhood (FTTN) systems. The OLT 122 can be connected to the ONTs 130 and ONUs 132 through a series of fiber link assemblies 134 and one or more fiber distribution hubs 136. The FTTP system may further include splicing components 138 for joining or separating fiber optic cable or, more particularly, one or more of the fibers within a cable.

The signals sent to a subscriber may represent media content such as a television program or movie for display on a monitor (e.g., a television screen), audio signals as part of a telephone call, and/or email and web pages as part of an Internet connection. The path on which the optical signals are sent from the source (e.g., the provider's central office) through the network to the subscriber may be considered a “line.” Portions of a line may be shared by several subscribers. Typically, the only part of the line unique for a particular subscriber (or, more specifically, the premises of the subscriber) is the last portion of the line from the optical network terminal located at or near the premises and a splicing component or a fiber distribution hub.

The service provider may provide a process for a subscriber to report a potential problem regarding his or her service, i.e., the delivering of the optical signals to his or her premises and/or the sending of signals from his or her premises onto the network. For example, the subscriber may call to report that the transmission of the signals to and from his or her premises has stopped completely or that the transmission is occurring at a slower rate than expected. As more specific examples, a subscriber may report that the cable or phone is out of service or the Internet connection is slow or non-existent.

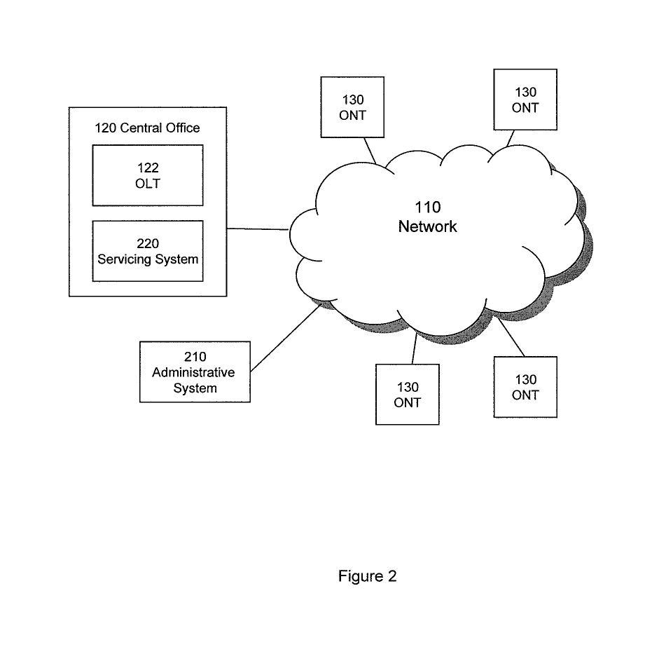

The process for reporting a problem may include a subscriber calling a predetermined telephone number, e.g., a customer service number. Through the service number, the subscriber may be directed to an operator of the service provider. The subscriber may relay any information that he or she knows about the problem, e.g., the nature of the problem, the duration of the problem, or the location of the problem. The operator may capture the information pertaining to the problem by entering it into a first system of the service provider, referred to herein as the administrative system 210 and illustrated in FIG. 2. The administrative system 210 may be part of a solution center, such as a FiOS solution center, maintained by the service provider to provide customer service to its subscribers. The administrative system 210 may include one or more general purpose computer devices and/or servers in communication with one another over a network, e.g., the PON 100 of the FTTP system or a network separate from the FTTP system. Although the administrative system 210 is illustrated in FIG. 2 as a single element, it is understood that the computer devices and servers of the administrative system 210 may be geographically dispersed.

As an example, the administrative system 210 may include a workstation for each operator and at least one memory element of the administrative system accessible by the workstations that stores the information entered into by each operator at his or her workstation, including reported problems from subscribers. Again, as an example, the administrative system may include at least a first server that includes the at least one memory element that stores the information about the reported problems.

The administrative system may be in communication with the network of the FTTP system such that the operator may be able to test the line associated with the subscriber who is calling about the problem in order to confirm the existence of a problem. The test may include sending a test signal to the premises of the subscriber and determining whether a signal is sent back from the premises in response to the test signal. Alternatively, the network may include one or more testing stations configured to monitor the transmission of the signals along lines of the network. The operator from the administrative system may be able to communicate with one or more testing stations along the line of the subscriber in order to confirm the existence of the problem.

Instead of or addition to the subscriber interacting with an operator to report a problem, the service provider may provide a more automatic or electronic process for reporting problems and capturing the information pertaining to the problems. For example, by calling the customer service number, the subscriber may be able to access an interactive voice response (“IVR”) system that is configured to respond to voice command or touch tones. The IVR system may allow the subscriber to report the potential problem and provide other information directly to the administrative system with no or minimal operator interaction. As another example, the service provider may provide a web portal, e.g., a web page, that is accessible to the subscriber and that allows the subscriber to report the potential problem and other information directly to the administrative system. In this example, the problem is identified and the information pertaining to the problem is captured by the submission of the information by the subscriber through the web portal.

The above primarily discusses the administrative system identifying a potential problem based on a subscriber first reporting it. However, in other embodiments, the service provider may identify one or more potential problems without the subscriber reporting it. For example, the administrative system may conduct routine tests of the lines of the network and/or receive reports from the test stations within the network. The administrative system may identify one or more potential problems based on these tests and reports with no or minimal input from the subscribers.

It should be noted that the subscriber or administrative system may be identifying a potential problem rather than an actual problem of the network. Therefore, in some instances, the operation or action of the subscriber or administrative system may be further clarified as providing or identifying an indication of a problem. Upon further investigation, it may be determined that the problem does not or did not exist.

Once the indication of the problem is identified, the operator and/or the administrative system may determine what actions may be taken to address the potential problem. For example, an action may be sending a technician to the premises of the subscriber or another location within the network in order to investigate and/or address the potential problem. In such instances, the administrative system may generate a “trouble ticket.” Although referred to as a ticket, it is understood that a trouble ticket can embody various forms including, but not limited to, an electronic message or notice. The trouble ticket may be sent to a second system, referred to as a servicing system 220 and illustrated in FIG. 2.

In general, the servicing system 220, among other things, is configured to dispatch technicians based on the trouble tickets received from the administrative system 210. A trouble ticket is considered “opened” if the potential problem that is the subject of the trouble ticket is unresolved. Once the potential problem is resolved, the trouble ticket is considered “closed.” For example, when a technician is dispatched to particular location, he or she may be able to fix or otherwise resolve the potential problem that is subject to the trouble ticket. In that case, the technician would notify the servicing system to close the trouble ticket. The servicing system is also configured to send a closure notification to the administrative system regarding the closing of the trouble ticket.

A certain amount of time, e.g., 24 hours to 72 hours, may elapse from when the trouble ticket is generated by the administrative system and received by the servicing system to when a technician is dispatched to investigate the problem. The amount of time may be dependent on the type of problem that is the subject of the trouble ticket, the number of other opened trouble tickets, and the number of technicians available. Regardless of the source, during that elapsed time, the problem that is the subject of the trouble ticket may cease to exist. For example, the problem may have been fixed by the subscriber or another source, fixed by the correction of another issue within the network, or may have been misidentified in the first place. In such cases, the technician may be dispatched for a problem that no longer exists which would essentially be a waste of resources, e.g., the time of the technician, of the service provider.

The administrative system may be configured to perform tests of the line associated with the problem at predetermined intervals. If a test indicates that the problem no longer exists, then the administrative system may be further configured to indicate that the corresponding trouble ticket is closed and to send a closure notification to the servicing system. Once the servicing system receives the closure notification then the serving system can update the queue of trouble tickets accordingly such that a technician is not dispatch for the closed trouble ticket. Thus, the likelihood of technician being dispatched for a problem that no longer exists is reduced.

The criteria of testing of the line at predetermined intervals by the administrative system may be determined for each trouble ticket by an operator. For example, when the operator receives the reported problem from the subscriber and generates or opens a trouble ticket for the problem, he or she may provide instructions for the administrative system to test the line corresponding to the problem at a predetermined interval until either the administrative system receives a closure notification from the servicing system for the trouble ticket or one of the tests indicates the problem is resolved. For the latter, the administrative system may be further configured to close the trouble ticket and send a closure notification to the servicing system.

Instead of the operator setting instructions for testing for each trouble ticket, an operator may provide a set of instructions for the administrative system to apply to all identified problems. For example, the set of instructions may include testing a line of an identified problem depending on the nature of the problem, the ability to test the line for the problem, and other factors. The amount of time between tests may vary depending on the nature of the problem, the overall number of identified problems and opened trouble tickets, and other factors.

A consideration for establishing the time interval at which to test the line may be the capacity of the network to perform the test or tests without interfering with the normal operations of the network. For example, depending on the number of tests being performed throughout the network or within a portion of the network and the capacity of the network (e.g., the bandwidth), a test or tests of lines in the network may interrupt (e.g., slow or stop) the transmission of non-test signals in the network. Therefore the operator or the administrative system may increase the time interval of testing (i.e., increase the amount of time between tests) to avoid or minimize the affect that the testing has within the system. As a more specific example, the administrative system may be configured to change the time interval between testing at least partially based on changes in the amount of non-test signals being transmitted in the network (e.g., the amount of traffic in the network versus bandwidth).

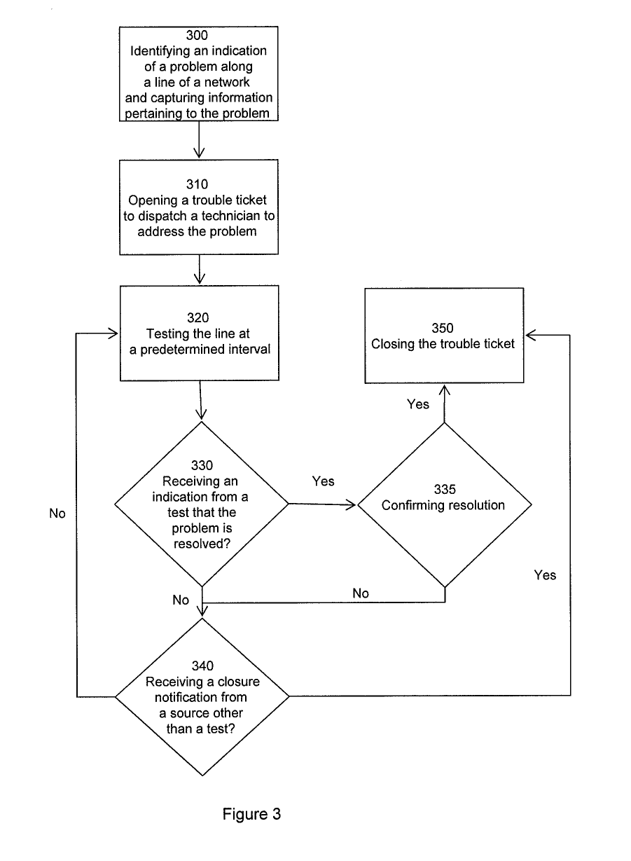

In general, the systems and operations explained above may reduce the likelihood of dispatching a technician to the field unnecessarily. As a more specific example and as illustrated in FIG. 3, an embodiment may provide a method that includes identifying an indication of a problem along a line of a network 300; opening a trouble ticket to dispatch a technician to address the problem 310; testing the line at a predetermined interval 320 until receiving an indication from a test that the problem is resolved 330 or receiving a closure notification from a source other than a test 340; and if the test does not provide an indication of resolution and no closure notification is received from another source then the operation of testing the line at a predetermined interval 320 continues. If a test indicates the resolution of the problem or a closure notification is received, the trouble ticket may be closed 350.

In other embodiments, the method may further include sending the trouble ticket to a first system, e.g., the servicing system, and sending a closure notification to the first system if a test indicates that the problem is resolved. As explained above, the identifying of the problem may be based at least partially on information provided by a subscriber.

Instances in which a test indicates resolution of the problem, the method of FIG. 3 may further include confirming the resolution before closing the trouble ticket 335. For example, the administrative system may include an autodial subsystem to call the subscriber affected by the problem or who initially reported the problem. The ability of the autodial subsystem to call the subscriber could be confirmation of resolution in instances where the problem would have prevented the call. Once connected to the subscriber, the system may include a prerecorded message informing the subscriber that the trouble ticket will be closed unless the subscriber instructs otherwise, e.g., by entering a command through an IVR system or by transferring to an operator. Or the subsystem may provide instructions to the subscriber to verify and otherwise confirm the problem has been resolved, again as an example, the interaction between the subscriber and the administrative system may be through an IVR feature.

Although most of the discussion has been directed to a trouble ticket for a problem, it is understood that the teachings herein apply equally in the context of multiple problems and multiple trouble tickets. For example, the method may include storing the trouble ticket illustrated in FIG. 3 along with a plurality of other trouble tickets corresponding to a plurality of other problems along a plurality of other lines of the network and testing the plurality of other lines of the network related to the plurality of other problems. The method may further include closing one or more of the plurality of other trouble tickets when either one or more tests indicate the resolution of the one or more problems corresponding to the one or more plurality of other trouble tickets or the receipt of one or more closure notifications from one or more sources other than a test regarding the one or more of the plurality of the other trouble tickets.

The operations described above and illustrated in FIG. 3 may be performed by the administrative system. More specifically, the administrative system may include a processor to perform the operations and at least one memory element for storing the trouble tickets and other information including software instructions for performing the operations. As described above, the administrative system may be configured to interact with the servicing system for sending trouble tickets and/or sending closure notifications. However, in other embodiments, one or more (or even all of) the operations of the administrative system and servicing system may be combined in one system.

The processor of the administrative system may be embodied various ways. For example, the processor may be as a coprocessor, a controller or various other processing means or devices including integrated circuits such as, for example, an application specific integrated circuit (“ASIC”).

The memory elements described herein may be various memory structures including volatile and non-volatile memory structures. Any of the memory elements may be configured to store information, data, applications, instructions or the like for enabling the devices disclosed herein to carry out various functions in accordance with exemplary embodiments, such as by storing software that is executable by the processor to cause the various functions of the processor that are described herein to be performed. For example, a memory element could be configured to buffer input data for processing by a respective processor.

Although the operations or functions described above have been attributed to mostly hardware components, such as a server or other computer device, one or more the operations or functions may be combined and performed through software or a combination of software or hardware. As an example, in some embodiments a computer program product stored on a computer-readable storage medium (i.e., software) comprising of one or more executable portions may perform the operations or functions described above.

In the preceding specification, various embodiments of the claimed invention have been described. It will, however, be evident that various modifications and changes may be made thereunto without departing from the broader spirit and scope of the invention as set forth in the claims that follow. The specification and drawings are accordingly to be regarded in an illustrative rather than restrictive sense.

That which is claimed:

1. A method comprising:
identifying an indication of a problem along a line of a network including capturing information pertaining to the problem;
opening a trouble ticket to dispatch a technician to address the problem;
testing the line at a predetermined interval following the opening of the trouble ticket until either receiving an indication from a test that the problem is resolved or receiving a closure notification from a source other than a test; and
closing the trouble ticket.

2. The method according to claim 1 further comprising sending the trouble ticket to a first system, wherein the first system is the source from which the closure notification is received.

3. The method according to claim 2 further comprising sending a closure notification to the source if a test indicates that the problem is resolved.

4. The method according to claim 3, wherein the identifying the problem is based at least partially on information provided from a subscriber of the network related to the problem.

5. The method according to claim 1 further comprising storing the trouble ticket along with a plurality of other trouble tickets corresponding to a plurality of other problems along a plurality of other lines of the network.

6. The method according to claim 5 further comprising testing the plurality of other lines of the network related to the plurality of other problems.

7. The method according to claim 6 further comprising closing one or more of the plurality of other trouble tickets when either one or more tests indicate the resolution of the one or more problems corresponding to the one or more of the plurality of other trouble tickets or the receipt of one or more closure notifications from one or more sources other than a test regarding the one or more of the plurality of other trouble tickets.

8. The method according to claim 1 further comprising confirming resolution of the problem in response to a test indicating that the problem is resolved before closing the trouble ticket.

9. A system comprising a processor configured to identify a problem along a line of a network; open a trouble ticket to dispatch a technician to address the problem; test the line at a predetermined interval until either receiving an indication from a test that the problem is resolved or receiving a closure notification from a source other than a test; and close the trouble ticket.

10. The system according to claim 9, wherein the processor is further configured to send the trouble ticket to a first system, wherein the first system is the source from which the closure notification is received.

11. The system according to claim 10, wherein the processor is further configured to send a closure notification to the source if a test indicates that the problem is resolved.

12. The system according to claim 11, wherein the processor is further configured to identify the problem based at least partially on information provided from a subscriber of the network related to the problem.

13. The system according to claim 9 further comprising at least one memory element and wherein the processor is further configured to store the trouble ticket along with a plurality of other trouble tickets corresponding to a plurality of other problems along a plurality of other lines of the network in the at least one memory element.

14. The system according to claim 13, wherein the processor is further configured to test the plurality of other lines of the network related to the plurality of other problems.

15. The system according to claim 14, wherein the processor is further configured to close one or more of the plurality of other trouble tickets when either one or more tests indicate the resolution of the one or more problems corresponding to the one or more of the plurality of other trouble tickets or the receipt of one or more closure notifications from one or more sources other than a test regarding the one or more of the plurality of other trouble tickets.

16. The system according to claim 9, wherein the processor is further configured to confirm resolution of the problem in response to a test indicating that the problem is resolved before closing the trouble ticket.

17. A computer program product comprising a computer-readable storage medium having computer-readable program code portions stored therein, the computer-readable program code portions comprising:
a first executable portion for identifying a problem along a line of a network;
a second executable portion for opening a trouble ticket to dispatch a technician to address the problem;
a third executable portion for testing the line at a predetermined interval until either receiving an indication from a test that the problem is resolved or receiving a closure notification from a source other than a test; and
a fourth executable portion for closing the trouble ticket.

18. The computer program product according to claim 17 further comprising a fifth executable portion for sending the trouble ticket to a first system, wherein the first system is the source from which the closure notification is received.

19. The computer program product according to claim 18 further comprising a sixth executable portion for sending a closure notification to the source if a test indicates that the problem is resolved.

20. The computer program product according to claim 19, wherein the first executable portion is configured to identify the problem based at least partially on information provided from a subscriber of the network related to the problem.

21. The computer program product according to claim 17 further comprising a fifth executable portion for storing the trouble ticket along with a plurality of other trouble tickets corresponding to a plurality of other problems along a plurality of other lines of the network.

22. The computer program product according to claim 21 further comprising a sixth executable portion for testing the plurality of other lines of the network related to the plurality of other problems.

23. The computer program product according to claim 22 further comprising a seventh executable portion for closing one or more of the plurality of other trouble tickets when either one or more tests indicate the resolution of the one or more problems corresponding to the one or more of the plurality of other trouble tickets or the receipt of one or more closure notifications from one or more sources other than a test regarding the one or more of the plurality of other trouble tickets.

24. The computer program product according to claim 17 further comprising a fifth executable portion for confirming resolution of the problem in response to a test indicating that the problem is resolve
